(19) United States
(12) Patent Application Publication
(10) Pub. No.: US 2022/0166232 A1
(43) Pub. Date: May 26, 2022

(54) CHARGING MANAGEMENT SYSTEM AND METHOD, DEVICE, AND STORAGE MEDIUM

(71) Applicant: AUTEL ROBOTICS CO,. LTD., Shenzhen (CN)

(72) Inventor: Wei QIN, Shenzhen (CN)

(21) Appl. No.: 17/650,685

(22) Filed: Feb. 11, 2022

Related U.S. Application Data
(63) Continuation of application No. PCT/CN2020/108932, filed on Aug. 13, 2020.

(30) Foreign Application Priority Data
Aug. 13, 2019 (CN) 201910744010.9

(51) Int. Cl. H02J 7/00

(52) U.S. Cl. CPC H02J 7/0019; H02J 7/0071; H02J 7/00718

(57) ABSTRACT

Embodiments of the present invention disclose a charging management system and method, a device, and a storage medium, wherein the system includes a microprocessor configured for acquiring current electric quantity parameters of at least two to-be-charged batteries; a control terminal of the microprocessor is connected to a controlled terminal of at least two charging circuit switches for determining whether to charge the at least two to-be-charged batteries according to the current electric quantity parameters and controlling an on-or-off state of any of the at least two charging circuit switches according to a working state of a power source. In the embodiments of the present invention, the microprocessor centrally manages a condition of charging multiple to-be-charged batteries with multiple power sources, without a DC-DC circuit, and realizing the automatic charging management of multiple to-be-charged batteries at reduced hardware costs.

### CROSS REFERENCE

The present application is a continuation of International Application No. PCT/CN2020/108932, filed on Aug. 13, 2020, which claims priority to Chinese patent application No. 201910744010.9, filed on Aug. 13, 2019, which is incorporated herein by reference in its entirety.

### BACKGROUND

### Technical Field

This application relates to charging management technologies, more particularly, to a charging management system and method, a device, and a storage medium.

### Related Art

Unmanned aerial vehicles (UAV) have been widely used in various fields because of their low cost and convenience.

Generally, batteries of existing unmanned aerial vehicles (UAV) cannot last long enough, and it is feasible for a UAV to carry multiple batteries for longer endurance. However, the process of charging multiple batteries is complex because it requires repetitive manual operation to connect each battery to and remove the same from a power interface. Besides, a single power source is generally now used to charge a battery, that is, a ready-made power module is taken, subject to stepping-down and shunting through a DC-DC step-down circuit, to manage the charging of multiple batteries, respectively. However, this power supply method needs a DC-DC step-down circuit, which costs more in the hardware design, and more importantly, when the charging power is too high, the hardware design costs even more to address heat treatment and electromagnetic compatibility of the high power supply.

### SUMMARY

Given the foregoing, the present invention provides a charging management system and method, a device, and a storage medium to automatically manage the charging of a to-be-charged battery at reduced hardware costs.

In a first aspect, embodiments of the invention provide a charging management system, including: a microprocessor, at least two power modules communicatively connected to the microprocessor, and at least two to-be-charged batteries communicatively connected to the microprocessor; wherein

each of the at least two power modules includes a power source, and at least two charging circuit switches configured for the power source;

each of the at least two charging circuit switches includes a controlled terminal, first data terminal, and a second data terminal;

an output terminal of the power source is connected to the first data terminal of each of the charging circuit switches, and the second data terminals of the at least two charging circuit switches are connected to the at least two to-be-charged batteries, respectively;

the microprocessor is configured to acquire current electric quantity parameters of the at least two to-be-charged batteries;

a control terminal of the microprocessor is connected to the controlled terminal of the at least two charging circuit switches to determine whether to charge the at least two to-be-charged batteries according to the current electric quantity parameters and control an on-or-off state of any of the at least two charging circuit switches according to a working state of the power source.

In a second aspect, embodiments of the present invention also provide a charging management method, including:

determining that the to-be-charged battery has been plugged in the charging management system and needs to be charged;

judging whether there is an idle power module in the at least two power modules; and

controlling the idle power module to charge the to-be-charged battery in a case of a positive judgment.

In a third aspect, embodiments of the present invention also provide a charging management device, including:

a first determination module for determining that the to-be-charged battery has been plugged in the charging management system and needs to be charged;

a first judgment module for judging whether there is an idle power module in the at least two power modules; and

a first control module for controlling the idle power module to charge the to-be-charged battery in a case of a positive judgment.

In a fourth aspect, embodiments of the present invention provide a computer-readable storage medium having stored thereon a computer program which, when executed by a processor, implements the charging management method as described in any of the above embodiments.

In the present invention, a communicative connection is established between the to-be-charged battery and the microprocessor to acquire current electric quantity parameters of the to-be-charged battery, the microprocessor determines whether to charge the to-be-charged battery according to the current electric quantity parameters, and the on-or-off state of a corresponding charging circuit switch is controlled according to the working state of the power source to supply power to the to-be-charged battery. The microprocessor centrally manages a condition of charging multiple to-be-charged batteries with multiple power sources, without a DC-DC circuit, and realizing the automatic charging management of multiple to-be-charged batteries at reduced hardware costs.

### BRIEF DESCRIPTION OF THE DRAWINGS

FIG. 1 is a schematic diagram showing a configuration of a charging management system according to an embodiment of the present invention;

FIG. 2 is a schematic diagram showing a configuration of another charging management system according to an embodiment of the present invention;

FIG. 3 is a schematic diagram showing a configuration of yet another charging management system according to an embodiment of the present invention;

FIG. 4 is a flowchart of a charging management method according to an embodiment of the present invention;

FIG. 5 is a flowchart of another charging management method according to an embodiment of the present invention;

FIG. 6 is a flowchart of yet another charging management method according to an embodiment of the present invention;

FIG. 7 is a flowchart of still another charging management method according to an embodiment of the present invention;

FIG. 8 is a block diagram of a charging management device according to an embodiment of the present invention.

### DETAILED DESCRIPTION

The present invention will now be described in further detail with reference to the accompanying drawings and examples. It should be understood that the particular embodiments described herein are illustrative only and are not restrictive. It should also be noted that, for ease of description, only some, but not all, of the structures associated with the present invention are shown in the drawings.

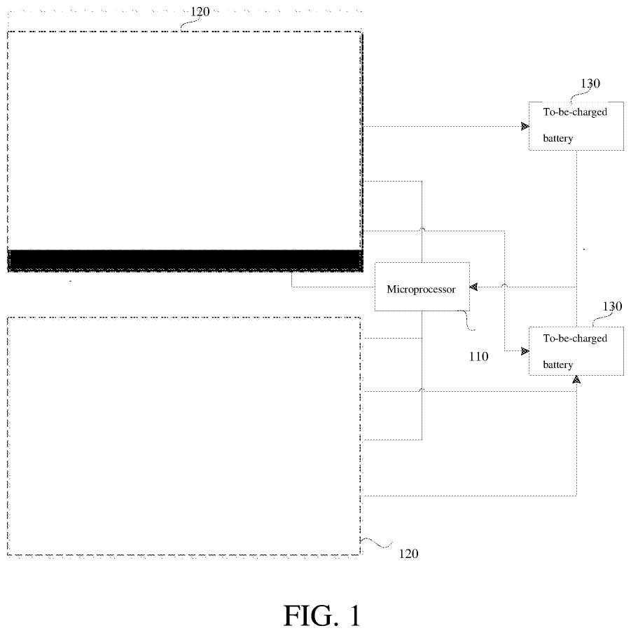

FIG. 1 is a schematic diagram of a charging management system according to an embodiment of the present invention, which is applicable to a case of the charging management of multiple to-be-charged batteries. The system includes a microprocessor 110, at least two power modules 120 communicatively connected to the microprocessor 110, and at least two to-be-charged batteries 130 communicatively connected to the microprocessor 110;

herein, each of the at least two power modules 120 includes a power source 1201 and at least two charging circuit switches 1202 configured for the power source 1201; each of the at least two charging circuit switches 1202 includes a controlled terminal, a first data terminal, and a second data terminal; an output terminal of the power source 1201 is connected to the first data terminal of each charging circuit switch 1202, and the second data terminals of the at least two charging circuit switches 1202 are connected to the at least two to-be-charged batteries 130, respectively;

the microprocessor 110 is configured to acquire current electric quantity parameters of the at least two to-be-charged batteries 130;

a control terminal of the microprocessor 110 is connected to the controlled terminal of the at least two charging circuit switches 1202 to determine whether to charge the at least two to-be-charged batteries 130 according to the current electric quantity parameters and control the on-or-off state of any of the at least two charging circuit switches 1202 according to a working state of the power source 1201.

Herein, the power source 1201 refers to a power source that can output constant voltage and constant current and independently charge a to-be-charged battery 130. In the embodiment, the constant voltage refers to a highest voltage the to-be-charged battery 130 can bear; the constant current refers to a maximum continuous current that the to-be-charged battery 130 can bear.

It should be noted herein that the technical solution of the embodiment is implemented on the ground that the power sources 1201 are no greater than the to-be-charged batteries 130, that is, when all the power sources 1201 are charging the to-be-charged batteries 130, respectively, there are still remaining to-be-charged batteries 130 waiting to be charged. It will be appreciated that the number of power sources 1201 is smaller than or equal to the number of to-be-charged batteries 130. It should be understood that the number of the power sources 1201 in the charging management system is arranged to be smaller than or equal to the number of the to-be-charged batteries 130 to ensure that the total power output of all the power sources 1201 is less than or equal to the total power required by all the to-be-charged batteries 130 so that the output power of the power source 1201 can be set directly according to the power required by each to-be-charged battery 130, without performing step-down processing on the voltage output by the power source 1201 with a DC-DC step-down circuit.

To facilitate the description of the relationship concerning the voltage and the current between the power source 1201 and the to-be-charged battery 130, in an embodiment, the highest voltages of all the to-be-charged batteries 130 are the same and so is the maximum continuous current. By way of example, if the charging management system has two power sources 1201, three to-be-charged batteries 130 need to be charged, the maximum voltage for each to-be-charged battery 130 is 4V, and the maximum continuous current for each to-be-charged battery 130 is 500 mA, then the power required for the to-be-charged battery 130 is 2 W; in this case, the power of each power source 1201 can be 2 W, the output voltage can be 4V, and the current can be 500 mA, so each power source 1201 can directly charge each to-be-charged battery 130 through a peripheral charging interface 140, without a DC-DC circuit for step-down processing. Besides, each power source 1201 itself is also an adapter for a single to-be-charged battery 130, and thus ensures the reliability of charging. Of course, in the embodiment, the maximum voltages of all the to-be-charged batteries 130 are the same, and so are the maximum continuous currents, which can be understood that the models of the to-be-charged batteries 130 are the same, that is, the power source 1201 is an adapter that can be shared by all the to-be-charged batteries 130, thereby reducing the development cost and shortening the development cycle.

Certainly, for the convenience of one power source 1201 to charge multiple to-be-charged batteries 130, each power source 1201 may be provided with multiple charging circuit switches 1202. Herein, each of the power sources 1201 may be connected to multiple to-be-charged batteries 130 through the charging circuit switch 1202. It can be understood that charging circuit switches 1202 are in one-to-one correspondence with the to-be-charged batteries 130, that is, each charging circuit switch 1202 corresponds to one to-be-charged battery 130. When the charging circuit switch 1202 receives an on-or-off instruction from the microprocessor 110, the charging circuit switch 1202 controls on or off of the charging circuit switch 1202 according to the on-or-off instruction, so that the power source 1201 charges the charging battery 130 through the charging circuit switch 1202.

In the technical solution of this embodiment, a communicative connection is established between the to-be-charged battery and the microprocessor to acquire current electric quantity parameters of the to-be-charged battery, the microprocessor determines whether to charge the to-be-charged battery according to the current electric quantity parameters, and the on-or-off state of a corresponding charging circuit switch is controlled according to the working state of the power source to supply power to the to-be-charged battery. The microprocessor centrally manages a condition of charging multiple to-be-charged batteries with multiple power sources, without a DC-DC circuit, and realizing the automatic charging management of multiple to-be-charged batteries at reduced hardware costs.

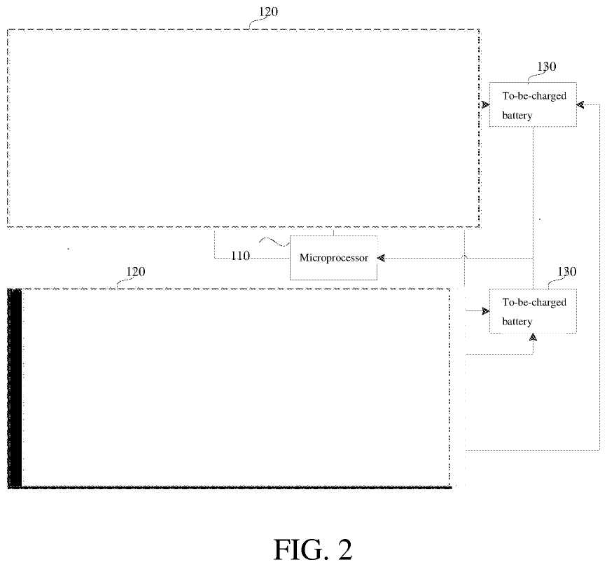

FIG. 2 is a schematic diagram showing a configuration of another charging management system according to an embodiment of the present invention. This embodiment further specifies the power module 120 on the basis of the embodiment described above. As shown in FIG. 2, the power module 120 in the charging management system of this embodiment further includes: a peripheral charging interface 1203, wherein a first terminal of the peripheral charging interface 1203 is connected to the second data terminal of the charging circuit switch 1202, and a second terminal of the peripheral charging interface 1203 is connected to the to-be-charged battery 130;

a second data terminal of the charging circuit switch 1202 charges the to-be-charged battery 130 through the corresponding peripheral charging interface 1203.

In an embodiment, the charging circuit switches 1202 are in a one-to-one correspondence with the peripheral charging interfaces 1203, that is, the number of the charging circuit switches 1202 and the number of the peripheral charging interfaces 1203 are the same. Illustratively, while the power source 1201 charges the to-be-charged battery 130, another to-be-charged battery 130 may also be connected through another peripheral charging interface 1203, in this way, after the power source 1201 completes charging the current to-be-charged battery 130, the microprocessor 110 automatically cuts off the charging circuit switch 1202 corresponding to the current to-be-charged battery 130 and controls the power source 1201 to charge another to-be-charged battery 130 that is to be charged and has been connected, without manual operation and improving the convenience of charging multiple to-be-charged batteries 130.

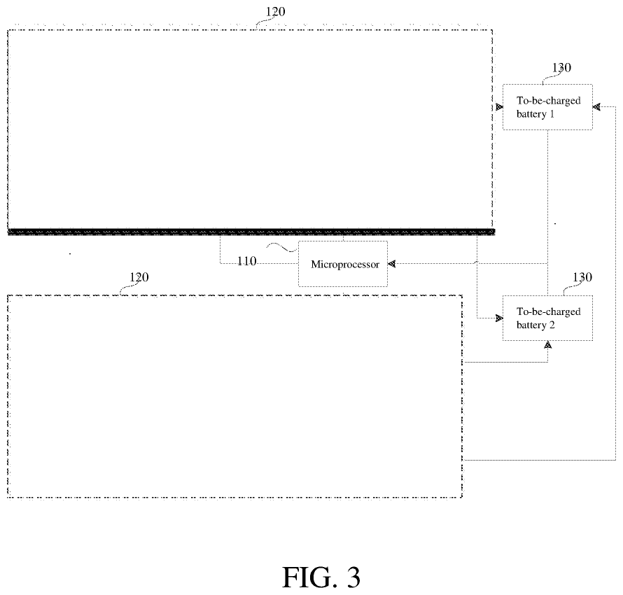

FIG. 3 is a schematic diagram showing a configuration of yet another charging management system according to an embodiment of the present invention. As shown in FIG. 3, it is assumed that the charging management system is provided with two power sources 1201 connected to two to-be-charged batteries 130 through the peripheral charging interface 1203 to which four charging circuit switches 1202 is connected, and communication ports of the two to-be-charged batteries 130 are respectively communicatively connected to communication ports of the microprocessor 110, moreover, the microprocessor 110 controls the four charging circuit switches 1202. Specifically, it is assumed that the two power sources 1201 include a power source 1 and a power source 2; each power source 1201 corresponds to two charging circuit switches 1202, wherein the power source 1 corresponds to a charging circuit switch 1 and a charging circuit switch 2, and the power source 2 corresponds to a charging circuit switch 3 and a charging circuit switch 4; each charging circuit switch 1202 corresponds to one peripheral charging interface 1203, wherein the charging circuit switches 1, 2, 3 and 4 correspond to peripheral charging interfaces 1, 2, 3 and 4, respectively; two to-be-charged batteries 130 need to be charged, namely a to-be-charged battery 1 and a to-be-charged battery 2. It can be understood that the power source 1 can charge the to-be-charged battery 1 as well as the to-be-charged battery 2, and whether to charge the to-be-charged battery 1 and the to-be-charged battery 2 is controlled by the microprocessor 110; accordingly, the power source 2 can charge the to-be-charged battery 1 as well as the to-be-charged battery 2, and whether to charge the to-be-charged battery 1 and the to-be-charged battery 2 is controlled by the microprocessor 110, thereby achieving the management of charging multiple to-be-charged batteries.

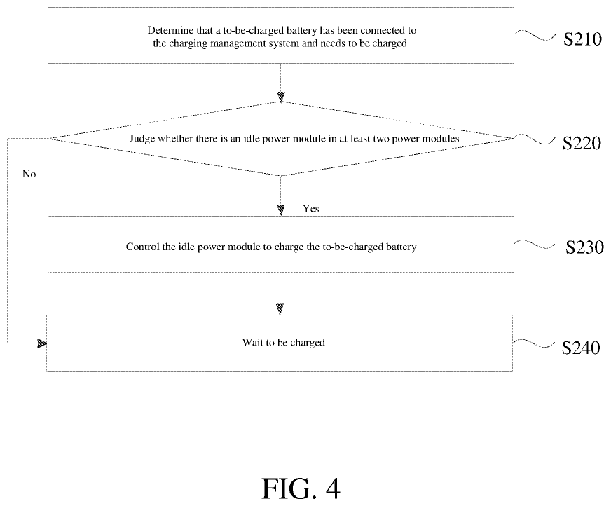

FIG. 4 is a flowchart of a charging management method provided by an embodiment of the present invention, which is applicable to a case of charging multiple to-be-charged batteries with multiple power sources controlled by the microprocessor when multiple to-be-charged batteries need to be charged, and this method can be performed by a charging management device, wherein the method can be implemented by means of hardware and/or software and can be generally integrated into the charging management system. The charging management method in this embodiment uses the charging management system described in the above embodiment and describes a process of charging management. As shown in FIG. 4, the method specifically includes the following steps.

In S210, the to-be-charged battery is determined to have accessed the charging management system and needs to be charged.

In the embodiment, if the to-be-charged battery is detected to have accessed the charging management system through the peripheral charging interface, whether the to-be-charged battery needs to be charged is considered, and if yes, step S220 is performed; if not, the charging management system enters a standby mode.

It should be noted that, for the power source to directly charge the to-be-charged battery connected to the peripheral charging interface without a DC-DC step-down circuit that performs step-down processing on the voltage output of the power source, the number of the to-be-charged batteries in the charging management system is greater than or equal to the number of the given power sources, that is, when all the power sources simultaneously charge the to-be-charged batteries, there are other remaining to-be-charged batteries waiting to be charged. A detailed explanation of this can be seen from the description of the embodiment described above, which will be omitted herein. Certainly, it is also possible that the charging management system has just started and there is no charging battery connected to the charging management system yet, and at this time, it is only necessary to ensure that the number of power sources on the charging management system is smaller than or equal to the number of charging to-be-charged batteries, that is, after the charging to-be-charged batteries are plugged in all the power sources on the charging management system, there still remains some charging to-be-charged batteries waiting to be charged.

In S220, a judgment is made on whether there is an idle power module in the at least two power modules, and if yes, step S230 is performed; if not, step S240 is performed.

In the embodiment, if a to-be-charged battery is detected to have been connected to the charging management system and the to-be-charged battery needs to be charged, it is then necessary to judge whether there is an idle power module in the charging management system, and if yes, the idle power module is controlled to charge the to-be-charged battery; if not, the to-be-charged battery waits to be charged.

In S230, the idle power module is controlled to charge the to-be-charged battery.

In the embodiment, after the microprocessor determines the idle power module corresponding to the to-be-charged battery, the microprocessor controls the charging circuit switch corresponding to the power source in the idle power module to turn on so that the power source charges the to-be-charged battery.

In S240, the to-be-charged battery waits to be charged.

In the technical solution of this embodiment, if it is determined that a to-be-charged battery has been plugged in the charging management system and needs to be charged, then whether there is an idle power module in the at least two power modules is subjected to judgment; if yes, the idle power module is controlled to charge the to-be-charged battery. The technical solution uses the microprocessor to control multiple power sources to charge multiple to-be-charged batteries, thereby realizing automatic charging management for multiple to-be-charged batteries at reduced hardware costs.

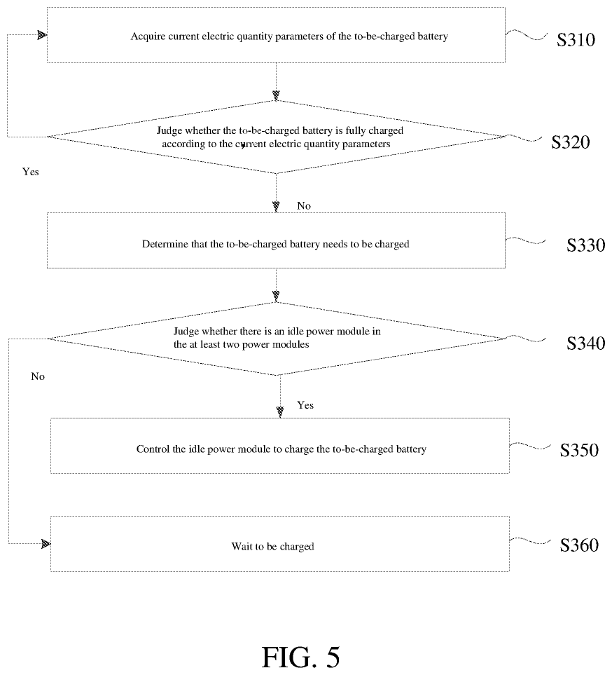

FIG. 5 is a flowchart of another charging management method provided by an embodiment of the present invention. This embodiment is based on the embodiment described above to further explain how to determine that the to-be-charged battery has been plugged in the charging management system and needs to be charged.

As shown in FIG. 5, the charging management method of this embodiment includes the following steps.

In S310, current electric quantity parameters of the to-be-charged battery are acquired.

Herein, the current electric quantity parameters include an electric quantity and a voltage of the to-be-charged battery. In an embodiment, when the to-be-charged battery is connected to the charging management system through the peripheral charging interface, the microprocessor can detect that the to-be-charged battery has been plugged in, and at this time, the microprocessor reads the current electric quantity parameters of the connected to-be-charged battery through the communication port thereof to determine whether the to-be-charged battery needs to be charged. The current electric quantity parameters can be information such as the electric quantity and voltage of the to-be-charged battery. In an embodiment, the microprocessor can determine which current charge parameters to read depending on the type of the to-be-charged battery. Illustratively, if the to-be-charged battery is a smart battery, the microprocessor reads information of an electric quantity of the smart battery and judges whether to charge on the basis of the information of the electric quantity; if the to-be-charged battery is a non-smart battery, the microprocessor reads a voltage parameter of the non-intelligent battery and judges whether to charge on the basis of the voltage parameter.

In S320, the current electric quantity parameters are taken to judge whether the to-be-charged battery is fully charged, and if yes, step S310 is performed; if not, step S330 is performed.

In the embodiment, after reading the current electric quantity parameters of the to-be-charged battery, the microprocessor determines whether the to-be-charged battery is fully charged according to the current electric quantity parameters, and if the to-be-charged battery is fully charged, it is not necessary to charge the battery, and the charging management system enters a standby mode; if the to-be-charged battery is not fully charged, the microprocessor searches for an idle power module from the given power modules, and uses the power source in the power module to charge the to-be-charged battery. Certainly, if there is no idle power module in the given power modules, the microprocessor has to wait and then determine the power module corresponding to the to-be-charged battery after other to-be-charged batteries are fully charged.

In the embodiment, whether the to-be-charged battery is fully charged may be determined on whether the current charge parameters of the to-be-charged battery reach a preset electric quantity threshold. Herein, the preset electric quantity threshold refers to the parameter information about the to-be-charged battery itself when the to-be-charged battery is in a fully charged state. For example, if the current electric quantity parameter is the electric quantity, then the preset electric quantity threshold refers to an electric quantity value of the to-be-charged battery itself when the to-be-charged battery is fully charged; if the current electric quantity parameter is the voltage, then the preset electric quantity threshold refers to a voltage value of the to-be-charged battery itself when the to-be-charged battery is fully charged. In an embodiment, whether the current electric quantity parameters of the to-be-charged battery reach the preset electric quantity threshold is judged to determine whether the to-be-charged battery is fully charged and then determining whether to charge the to-be-charged battery.

In S330, a determination is made that the to-be-charged battery needs to be charged.

In the embodiment, the current electric quantity parameter of the to-be-charged battery not reaching the preset power threshold indicates that the to-be-charged battery is not fully charged, that is, it is necessary to charge the to-be-charged battery. Each power module can only charge one to-be-charged battery at the same time, so the microprocessor is required to acquire a working state of each power module in the charging management system and to determine whether there is a power source currently in an idle state. Herein, the working state of the power module refers to a current state of the power source. In an embodiment, the working state of the power source can include a charging state and an idle state.

In S340, a judgment is made on whether there is an idle power module in the at least two power modules, and if yes, step S350 is performed; if not, step S360 is performed.

In the embodiment, whether there is an idle power module can be determined by monitoring the presence of a charging current in the power modules or the on-or-off state of each charging circuit switch of the power modules.

In one embodiment, determining whether there is an idle power module in the at least two power modules includes detecting whether a charging current exists in each of the at least two power modules, and if not, judging that there is an idle power module in the at least two power modules.

In an embodiment, whether there is an idle power module may be determined by the presence or absence of the charging current in each of the power modules. It can be understood that when the power module is charging the to-be-charged battery, the power module has to deliver a charging current to the to-be-charged battery. Therefore, the working state of the power module can be determined by the presence or absence of the charging current. If the charging current exists in each power module in the charging management system, then all the power modules in the charging management system are in a working state, that is, there is no idle power module; if the charging current exists in any of the power modules in the charging management system, then an idle power module does exist in the charging management system.

In one embodiment, determining whether there is an idle power module in the at least two power modules includes detecting whether the at least two charging circuit switches in each of the at least two power modules are both in an “off” state; if yes, a determination is made that there is an idle power module in the at least two power modules.

In the embodiment, whether there is an idle power module in the charging management system can be determined by judging whether all the charging circuit switches corresponding to each power module in the charging management system are in an “off” state. Specifically, each power module includes at least two charging circuit switches, and for all the charging circuit switches in one power module to switch to an “off” state indicates that the power module is in an idle state; if one of the charging circuit switches of one power module is in an “on” state, then the power module is charging the to-be-charged battery.

Of course, during actual operation, whether there is an idle power module in the charging management system can be determined by considering both whether there is a charging current in each power module and whether all the charging circuit switches in each power module are in an “off” state, and this enables a more accurate determination as to whether there is an idle power module, thereby ensuring the accuracy and efficiency of charging the charging battery.

In S350, the idle power module is controlled to charge the to-be-charged battery.

In the embodiment, after determining a working state of each power module in the charging management system, the microprocessor determines a power module of which the working state is idle as a target power module corresponding to the to-be-charged battery, that is, to charge the to-be-charged battery by the target power module. It should be noted herein that, the number of the to-be-charged batteries in the charging management system is greater than or equal to the number of the given power modules, that is, when the to-be-charged batteries are charged by each power module, there are still some remaining to-be-charged batteries waiting to be charged. Therefore, only after the power module completes charging the currently connected to-be-charged battery can one of the remaining to-be-charged batteries be charged. It will be understood that during the operation of the charging management system, it is not necessary to consider the simultaneous presence of multiple power modules in an idle state.

Illustratively, it is assumed that the steps of the charging management method are explained by taking the charging management system shown in FIG. 3 as an example. Specifically, the to-be-charged battery 1 is charged by the power source 1, and at this time, if the charging management system has the to-be-charged battery 2 plugged therein and the microprocessor determines that the power source 2 is in an idle state, then the microprocessor controls the charging circuit switch 3 to turn on and to charge the to-be-charged battery 2 by the power source 2. If another to-be-charged battery 3 is connected to the charging management system at this time, given the power source 1 and the power source 2 in the charging management system are both in a charging state, the to-be-charged battery 3 has to wait for charging, and once there is a to-be-charged battery that completes being charged, the microprocessor cuts off the charging circuit switch corresponding to the to-be-charged battery and takes an idle power source to charge the to-be-charged battery 3.

In S360, the to-be-charged battery waits to be charged.

The technical solution of this embodiment, on the basis of the embodiment described above, by means of detecting whether there is a charging current in each power module in the charging management system and detecting whether the at least two charging circuit switches in each power module are both in an “off” state, enables an accurate judgment on whether there is an idle power module in the charging management system, thereby improving the efficiency of power supply management for the charging battery.

On the basis of the embodiments described above, it is necessary to configure power supply parameters of the power source need before the charging management of the to-be-charged battery. In the embodiment, how to configure the power supply parameters is described by taking a power supply voltage and a power supply current of the power source as an example. Before determining that the to-be-charged battery has been connected to the charging management system, the method further includes: configuring the power supply voltage and the power supply current of each power source in the at least two power modules on the basis of a maximum charging voltage and a maximum charging current of the to-be-charged battery.

Herein, the maximum charging voltage refers to a value of the maximum voltage the to-be-charged battery can bear; the maximum charging current refers to a value of the maximum current the to-be-charged battery can bear. In the embodiment, to ensure that the power source in each power module can directly charge a to-be-charged battery without a DC-DC step-down circuit to perform step-down processing on the voltage output by the power source, the power supply voltage and the power supply current of each power source in each power module need to be configured before the charging management system is taken to manage the charging of the to-be-charged battery. Herein, to ensure that the power supply voltage and the power supply current of each power source in each power module conform to the voltage and the current required by the to-be-charged battery, the power supply voltage and the power supply current of each power source in each power module can be configured on the basis of the maximum charging voltage and the maximum charging current of the to-be-charged battery. Illustratively, it is assumed that the maximum charging voltage and the maximum charging current of the to-be-charged battery are 4 V and 500 mA, respectively, and thus the supply voltage and the supply current of each power source in each power module can be set to be 4 V and 500 mA, respectively. Certainly, the configuration of the power supply voltage and the power supply current of each power source in each power module is not defined herein, and they can be configured according to an actual situation of the to-be-charged battery.

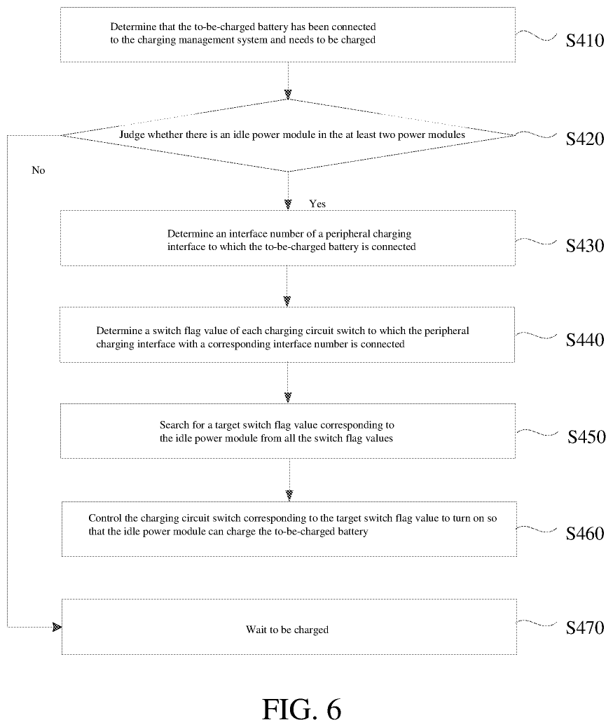

On the basis of the embodiments described above, controlling the idle power module to charge the to-be-charged battery is further explained. FIG. 6 is a flowchart of yet another charging management method provided by an embodiment of the present invention. As shown in FIG. 6, the method specifically includes the following steps.

In S410, the to-be-charged battery is determined to have accessed the charging management system and needs to be charged.

In S420, a judgment is made on whether there is an idle power module in the at least two power modules, and if yes, step S430 is performed; if not, step S470 is performed.

In S430, an interface number of the peripheral charging interface to which the to-be-charged battery is connected is determined.

Herein, the interface number refers to a serial number of each peripheral charging interface. In an embodiment, each peripheral charging interface corresponds to one interface number. Certainly, each to-be-charged battery can be connected to multiple peripheral charging interfaces, that is, there may be multiple interface numbers for the peripheral charging interfaces to which each to-be-charged battery is connected. It should be noted that each to-be-charged battery can be charged by the power source in each power module in the charging management system; moreover, to ensure efficient use of the peripheral charging interface of the power source in each power module, each to-be-charged battery has only to connect to one peripheral charging interface corresponding to the power source in each power module, that is, the number of the peripheral charging interfaces connected to all the to-be-charged batteries is the same as the number of power modules in the charging management system.

In S440, a switch flag value of each charging circuit switch connected to the peripheral charging interface with a corresponding interface number is determined.

Herein, the switch flag value refers to a serial number corresponding to each charging circuit switch to distinguish one charging circuit switch from another. In the embodiment, each charging circuit switch corresponds to one switch flag value. To facilitate the determination of a correspondence between the peripheral charging interface and the charging circuit switch, a mapping can be established between the peripheral charging interface and the charging circuit switch, and after determining the interface number of the peripheral charging interface to which the to-be-charged battery is connected, the microprocessor can directly search for the switch flag value of each charging circuit switch corresponding to the interface number on the basis of the mapping. Each to-be-charged battery corresponds to multiple peripheral charging interfaces, accordingly, so each to-be-charged battery corresponds to multiple charging circuit switches, that is, each to-be-charged battery corresponds to multiple switch flag values.

In S450, a target switch flag value corresponding to the idle power module is searched for from all the switch flag values.

The target switch flag value refers to a switch flag value corresponding to a charging circuit switch that is connected to both a target power source (i.e., a power source in an idle power module) and a to-be-charged battery. In the embodiment, after determining the switch flag value of each charging circuit switch to which the peripheral charging interface with a certain interface number is connected, the microprocessor acquires the switch flag value of the charging circuit switch to which the target power source is connected as the target switch flag value and searches for the target switch flag value from all the switch flag values.

In S460, the charging circuit switch corresponding to the target switch flag value is controlled to turn on so that the idle power module charges the to-be-charged battery.

In the embodiment, after acquiring the target switch flag value, the microprocessor controls the charging circuit switch corresponding to the target switch flag value to turn on so that the target power source charges the to-be-charged battery.

In S470, the to-be-charged battery waits to be charged.

In the technical solution of this embodiment, on the basis of the embodiment described above, a switch flag value of each corresponding charging circuit switch is determined on the basis of an interface number of the peripheral charging interface to which the to-be- charged battery is connected, a target switch flag value corresponding to a target power source is found from all the switch flag values, and a charging switch circuit corresponding to the target switch flag value is controlled to turn on so that the target power source charges the to-be-charged battery, thereby realizing effective management of charging multiple to-be-charged batteries.

On the basis of the embodiment described above, the charging management system changes a working mode if all the to-be-charged batteries in the charging management system are fully charged. Specifically, the charging management method further includes judging whether the at least two to-be-charged batteries in the charging management system are all fully charged, and if yes, controlling the charging management system to enter a standby mode.

In the embodiment, after the charging management system is started, it is necessary to judge on the current electric quantity parameters of the to-be-charged batteries and determine whether they are in a fully charged state, and if all the to-be-charged batteries are in a fully charged state, then the charging management system is controlled to enter a standby mode and waits for a to-be-charged battery needing to be charged to get plugged in.

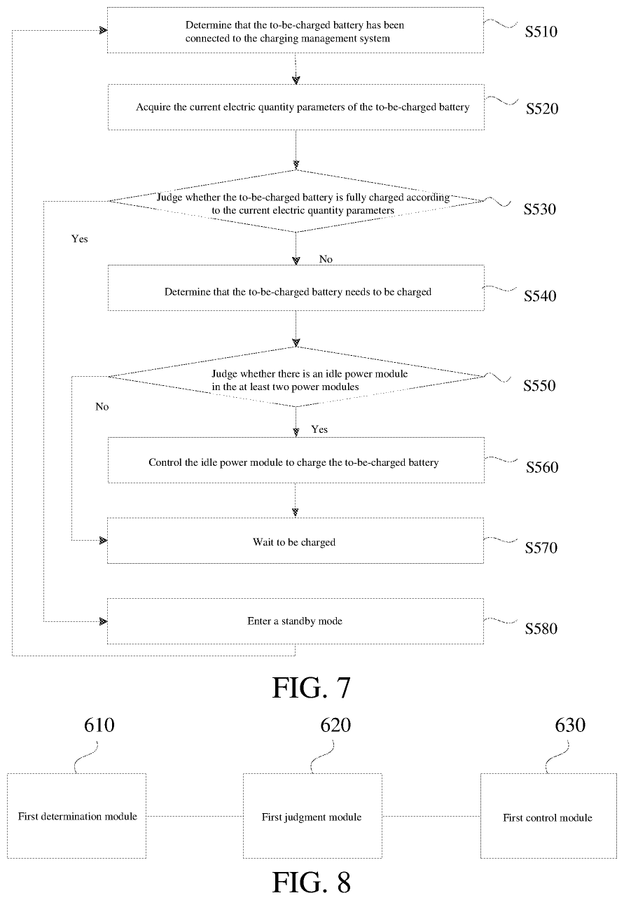

On the basis of the embodiment described above, the charging management method is further explained. FIG. 7 is a flowchart of still another charging management method provided by an embodiment of the present invention. It is to be noted herein that an entire process of the charging management method is specifically described by taking the charging management system shown in FIG. 2 as an example.

As shown in FIG. 7, the method specifically includes the steps of:

S510, determining that a to-be-charged battery has been connected to the charging management system;

S520, acquiring current electric quantity parameters of the to-be-charged battery;

wherein the current electric quantity parameters include an electric quantity and a voltage of the to-be-charged battery;

S530, judging whether the to-be-charged battery is fully charged on the basis of the current electric quantity parameters, if not, performing step S540, and if yes, performing step S580;

S540, determining that the to-be-charged battery needs to be charged;

S550, judging whether there is an idle power module in the at least two power modules, if yes, performing step S560, and if not, performing step S570;

S560, controlling the idle power module to charge the to-be-charged battery;

S570, waiting to be charged; and

S580, entering a standby mode.

In the embodiment, it is assumed that the power source 1 in the power module 1 has been taken to charge the to-be-charged battery 1, the to-be-charged battery 2 is detected to connect the peripheral charging interface, and the to-be-charged battery 3 is waiting to be charged, then the microprocessor acquires the current electric quantity parameters of the to-be-charged battery 2; the current electric quantity value of the to-be-charged battery 2 is compared with a preset electric quantity threshold, and the current electric quantity value not reaching the preset electric quantity threshold indicates that the to-be-charged battery 2 needs to be charged, and at this moment, it is necessary to control the charging circuit switch 3 corresponding to the peripheral charging interface 3 to turn on to charge the to-be-charged battery 2. The to-be-charged battery 3 in the charging management system is still waiting to be charged, so after the to-be-charged battery 1 and the to-be-charged battery 2 is fully charged, the microprocessor can directly control the charging circuit switch connected to the to-be-charged battery 3 to turn on to charge the to-be-charged battery 3 automatically.

In the technical solution of this embodiment, using multiple power sources to charge the to-be-charged batteries can eliminate a cumbersome DC-DC circuit; moreover, the power source itself is an adapter for a single to-be-charged battery, so the reliability of charging by the power source is ensured; in addition, the adapter for a single to-be-charged battery can be shared, so the development costs and cycle can be greatly shortened. Furthermore, multiple power sources are taken to supply power, respectively, for the charging management of multiple high-power to-be-charged batteries, and a microprocessor is taken to control the multiple power sources centrally, which can effectively manage the problem of charging multiple to-be-charged batteries, and the charging management system is simple in structure, easy to control, easy to expand, and high in stability, facilitates the control and management of a high-power multiple battery system, and effectively solves the complex problem of a user having to operate manually for charging multiple to-be-charged batteries.

FIG. 8 is a block diagram of a charging management device adapted to the charging management of multiple to-be-charged batteries, which can be implemented by hardware/software, according to an embodiment of the present invention. As shown in FIG. 8, the device includes: a first determination module 610, a first judgment module 620, and a first control module 630.

Herein, the first determination module 610 is configured to determine that a to-be-charged battery has been plugged in the charging management system and needs to be charged;

the first judgment module 620 is configured to judge whether there is an idle power module in the at least two power modules; and

the first control module 630 is configured to, if yes, control the idle power module to charge the to-be-charged battery.

In the technical solution of this embodiment, if it is determined that a to-be-charged battery has been plugged in the charging management system and needs to be charged, then whether there is an idle power module in the at least two power modules is subjected to judgment; if yes, the idle power module is controlled to charge the to-be-charged battery. The technical solution uses the microprocessor to control multiple power sources to charge multiple to-be-charged batteries, thereby realizing automatic charging management for multiple to-be-charged batteries at reduced hardware costs.

On the basis of the embodiment described above, the first determination module includes:

an acquisition unit for acquiring current electric quantity parameters of the to-be-charged battery, wherein the current electric quantity parameters include an electric quantity and a voltage of the to-be-charged battery;

a first judgment unit for judging whether the to-be-charged battery is fully charged according to the current electric quantity parameters;

a first determination unit for, if not, determining that the to-be-charged battery needs to be charged.

On the basis of the embodiment described above, the first determination module includes:

a first detection unit for detecting whether a charging current exists in each of the at least two power modules; and

a second determination unit for, if not, judging that there is an idle power module in the at least two power modules.

On the basis of the embodiment described above, the first determination module includes:

a second detection unit for detecting whether the at least two charging circuit switches in each of the at least two power modules are both in an “off” state; and

a third determination unit for, if yes, judging that there is an idle power module in the at least two power modules.

On the basis of the embodiment described above, the charging management device further includes: a configuration module for configuring a power supply voltage and a power supply current of each power source in the at least two power modules according to a maximum charging voltage and a maximum charging current of the to-be-charged battery before determining that the to-be-charged battery has been connected to the charging management system.

On the basis of the above embodiment, the first control module includes:

a fourth determination unit for determining an interface number of a peripheral charging interface to which the to-be-charged battery is connected;

a fifth determination unit for determining a switch flag value of each charging circuit switch to which the peripheral charging interface with the corresponding interface number is connected;

a search unit for searching for a target switch flag value corresponding to the idle power module from all the switch flag values; and

a control-to-charge unit for controlling a charging circuit switch corresponding to the target switch flag value to turn on so that the idle power module charges the to-be-charged battery.

On the basis of the embodiment described above, the charging management device further includes:

a second judgment module for judging whether the at least two to-be-charged batteries in the charging management system are all fully charged; and

a second control module for, if yes, controlling the charging management system to enter a standby mode.

The charging management device described above can perform the charging management method according to any embodiment of the present invention and has functional modules for performing the method and corresponding advantageous effects.

Embodiments of the present invention also provide a computer-readable storage medium having stored thereon a computer program, wherein when executed by a processor, the computer program implements the charging management method provided by embodiments of the present invention, and the method includes:

determining that a to-be-charged battery has been connected to the charging management system and needs to be charged; judging whether there is an idle power module in the at least two power modules; if yes, controlling the idle power module to charge the to-be-charged battery.

The computer storage medium according to embodiments of the present invention may take the form of any combination of one or more computer-readable media. The computer-readable medium may be a computer-readable signal medium or a computer-readable storage medium. The computer-readable storage medium can be, for example, but not limited to, an electronic, magnetic, optical, electromagnetic, infrared, or semiconductor system, apparatus, or device, or any combination thereof. More specific examples (a non-exhaustive list) of the computer-readable storage medium include: an electrical connection having one or more wires, a portable computer disk, a hard drive, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof. Herein, the computer-readable storage medium may be any tangible medium that can contain or store a program for use by or in connection with an instruction execution system, apparatus, or device.

The computer-readable signal medium may include data signals embodied in baseband or propagated as part of a carrier wave, which carry computer-readable program code. Such propagated data signals may take many forms, including but not limited to electromagnetic signals, optical signals, or any suitable combination thereof. The computer-readable signal medium may also be any computer-readable medium, other than a computer-readable storage medium, which can send, propagate, or transport the program for use by or in connection with the instruction execution system, apparatus, or device.

The program code embodied on the computer-readable medium may be transmitted over any suitable medium including, but not limited to, Wi-Fi, a wire, a fiber optic cable, radio frequency, and the like, or any suitable combination thereof.

Computer program code for implementing the present invention may be written in one or more programming languages, including object-oriented programming languages, such as Java, Smalltalk, C++, and conventional procedural programming languages, such as C or similar programming languages, or a combination thereof. The program code may be executed entirely on a user's computer, partly on the user's computer, as a stand-alone software package, partly on the user's computer and partly on a remote computer, or entirely on the remote computer or server. In the case of a remote computer, the remote computer may be connected to the user's computer through any type of network, including a local area network (LAN) or a wide area network (WAN), or may be connected to an external computer for example, through an Internet connection provided by an Internet Service Provider.

It should be noted that the above-mentioned description is only preferred embodiments of the present invention and the technical principles applied thereto. It will be understood by those skilled in the art that the present invention is not limited to the particular embodiments described herein, and that various obvious changes, rearrangements and substitutions can be made by those skilled in the art without departing from the scope of the invention. Therefore, while the invention has been described in considerable detail with reference to the above embodiments, it is to be understood that the invention is not limited to the above embodiments, but it is intended to cover various other equivalent embodiments without departing from the spirit of the invention, the scope of which is defined by the appended claims.

1. A charging management system, comprising: a microprocessor, at least two power modules communicatively connected to the microprocessor, and at least two to-be-charged batteries communicatively connected to the microprocessor; wherein
each of the at least two power modules comprises a power source, and at least two charging circuit switches configured for the power source;
each of the at least two charging circuit switches comprises a controlled terminal, first data terminal, and a second data terminal;
an output terminal of the power source is connected to the first data terminal of each of the charging circuit switches, and the second data terminals of the at least two charging circuit switches are connected to the at least two to-be-charged batteries, respectively;
the microprocessor is configured to acquire current electric quantity parameters of the at least two to-be-charged batteries;
a control terminal of the microprocessor is connected to the controlled terminal of the at least two charging circuit switches to determine whether to charge the at least two to-be-charged batteries according to the current electric quantity parameters and control an on-or-off state of any of the at least two charging circuit switches according to a working state of the power source.

2. The charging management system according to claim 1, wherein the power module further comprises a peripheral charging interface, a first terminal of the peripheral charging interface is connected to the second data terminal of the charging circuit switch, and a second terminal of the peripheral charging interface is connected to the to-be-charged battery;
the second data terminal of the charging circuit switch charges the to-be-charged battery through a corresponding peripheral charging interface.

3. The charging management system according to claim 1, wherein a number of power sources is less than or equal to a number of the to-be-charged batteries.

4. A charging management method for a charging management system, the charging management system comprising:
a microprocessor, at least two power modules communicatively connected to the microprocessor, and at least two to-be-charged batteries communicatively connected to the microprocessor; wherein
each of the at least two power modules comprises a power source, and at least two charging circuit switches configured for the power source;
each of the at least two charging circuit switches comprises a controlled terminal, first data terminal, and a second data terminal;
an output terminal of the power source is connected to the first data terminal of each of the charging circuit switches, and the second data terminals of the at least two charging circuit switches are connected to the at least two to-be-charged batteries, respectively;
the microprocessor is configured to acquire current electric quantity parameters of the at least two to-be-charged batteries;
a control terminal of the microprocessor is connected to the controlled terminal of the at least two charging circuit switches to determine whether to charge the at least two to-be-charged batteries according to the current electric quantity parameters and control an on-or-off state of any of the at least two charging circuit switches according to a working state of the power source;
wherein the charging management method comprises:
determining that the to-be-charged battery has been connected to the charging management system and needs to be charged;
judging whether there is an idle power module in the at least two power modules; and
if yes, controlling the idle power module to charge the to-be-charged battery.

5. The method according to claim 4, wherein said determining that the to-be-charged battery has been connected to the charging management system and needs to be charged comprises:
acquiring current electric quantity parameters of the to-be-charged battery, wherein the current electric quantity parameters comprise an electric quantity and a voltage of the to-be-charged battery;
judging whether the to-be-charged battery is fully charged according to the current electric quantity parameters; and
if not, determining that the to-be-charged battery needs to be charged.

6. The method according to claim 4, wherein said determining whether there is an idle power module in the at least two power modules comprises:
detecting whether a charging current exists in each of the at least two power modules; and
if not, judging that there is an idle power module in the at least two power modules.

7. The method according to claim 4, wherein said determining whether there is an idle power module in the at least two power modules comprises:
detecting whether the at least two charging circuit switches in each of the at least two power modules are both in an “off” state; and
if yes, judging that there is an idle power module in the at least two power modules.

8. The method according to claim 4, before said determining that the to-be-charged battery has been connected to the charging management system, further comprising:
configuring a power supply voltage and a power supply current of each power source in the at least two power modules according to a maximum charging voltage and a maximum charging current of the to-be-charged battery.

9. The method according to claim 4, wherein said controlling the idle power module to charge the to-be-charged battery comprises:
determining an interface number of the peripheral charging interface to which the to-be-charged battery is connected;
determining a switch flag value of each charging circuit switch to which the peripheral charging interface with the corresponding interface number is connected;
searching for a target switch flag value corresponding to the idle power module from all the switch flag values; and
controlling a charging circuit switch corresponding to the target switch flag value to turn on so that the idle power module charges the to-be-charged battery.

10. The method according to claim 4, further comprising:
judging whether the at least two to-be-charged batteries in the charging management system are all fully charged; and
if yes, controlling the charging management system to enter a standby mode.

11. A charging management device for a charging management system, the charging management system comprising:
a microprocessor, at least two power modules communicatively connected to the microprocessor, and at least two to-be-charged batteries communicatively connected to the microprocessor; wherein
each of the at least two power modules comprises a power source, and at least two charging circuit switches configured for the power source;
each of the at least two charging circuit switches comprises a controlled terminal, first data terminal, and a second data terminal;
an output terminal of the power source is connected to the first data terminal of each of the charging circuit switches, and the second data terminals of the at least two charging circuit switches are connected to the at least two to-be-charged batteries, respectively;
the microprocessor is configured to acquire current electric quantity parameters of the at least two to-be-charged batteries;
a control terminal of the microprocessor is connected to the controlled terminal of the at least two charging circuit switches to determine whether to charge the at least two to-be-charged batteries according to the current electric quantity parameters and control an on-or-off state of any of the at least two charging circuit switches according to a working state of the power source;
wherein the device comprises:
at least one processor; and
a memory communicatively coupled to the at least one processor; wherein,
the memory stores instructions executable by the at least one processor to enable the at least one processor to:
determine that the to-be-charged battery has been connected to the charging management system and needs to be charged;
judge whether there is an idle power module in the at least two power modules; and
if yes, control the idle power module to charge the to-be-charged battery.

12. The device according to claim 11, wherein the processor is further configured to:
acquire current electric quantity parameters of the to-be-charged battery, wherein the current electric quantity parameters comprise an electric quantity and a voltage of the to-be-charged battery;
judge whether the to-be-charged battery is fully charged according to the current electric quantity parameters; and
if not, determine that the to-be-charged battery needs to be charged.

13. The device according to claim 11, wherein the processor is further configured to:
detect whether a charging current exists in each of the at least two power modules; and
if not, judge that there is an idle power module in the at least two power modules.

14. The device according to claim 11, wherein the processor is further configured to:
detect whether the at least two charging circuit switches in each of the at least two power modules are both in an “off” state; and
if yes, judge that there is an idle power module in the at least two power modules.

15. The device according to claim 11, wherein the processor is further configured to:
configure a power supply voltage and a power supply current of each power source in the at least two power modules according to a maximum charging voltage and a maximum charging current of the to-be-charged battery before determining that the to-be-charged battery has been connected to the charging management system.

16. The device according to claim 11, wherein the processor is further configured to:
determine an interface number of the peripheral charging interface to which the to-be-charged battery is connected;
determine a switch flag value of each charging circuit switch to which the peripheral charging interface with the corresponding interface number is connected;
search for a target switch flag value corresponding to the idle power module from all the switch flag values; and
control a charging circuit switch corresponding to the target switch flag value to turn on so that the idle power module charges the to-be-charged battery.

17. The device according to claim 11, wherein the processor is further configured to:
judge whether the at least two to-be-charged batteries in the charging management system are all fully charged; and
if yes, control the charging management system to enter a standby mode.
